(19) United States
(12) Patent Application Publication
(10) Pub. No.: US 2023/0075575 A1
(43) Pub. Date: Mar. 9, 2023

(54) AQUEOUS COATING COMPOSITIONS

(71) Applicant: Dow Global Technologies LLC, Midland, MI (US)

(72) Inventors: Cheng Shen, Shanghai (CN); Yan Li, Shanghai (CN); Jian Zou, Shanghai (CN); Shaoguang Feng, Shanghai (CN); Hongying Wang, Shanghai (CN)

(21) Appl. No.: 17/758,271

(22) PCT Filed: Mar. 31, 2020
(86) PCT No.: PCT/CN2020/082326

§ 371 Date: Jun. 30, 2022

(51) Int. Cl. C09D 133/08; C09D 7/63; C09D 5/02

(52) U.S. Cl. CPC C09D 133/08; C09D 7/63; C09D 5/022; C08K 5/06

(57) ABSTRACT

Provided is an aqueous coating composition comprising a binder and a coalescent which is based on a secondary alcohol alkoxylate or a tertiary alcohol alkoxylate.

### FIELD

The present invention relates to aqueous coating compositions.

### INTRODUCTION

The continuous pursuit of high performance coatings, such as paint and other architectural coatings, with low volatile organic compounds (VOC) and low odor features has driven the development of new coating formulations. Among the various ingredients in water-based architectural coatings, coalescents and freeze-thaw (F-T) agents are often considered as two major VOC contributors based on the amounts used and their boiling points. Commonly used coalescents (e.g., ester alcohols) and F-T agents (e.g., propylene glycol) are often considered VOC contributors in water-based architectural coating formulations.

One common approach to meet low VOC targets for water-based architectural coatings (e.g., paints) has been to lower the glass transition temperature (Tg) of the binder used, or alternatively to use non-volatile coalescents in binders. However, the use of some non-volatile coalescents can result in compromised performance due to hardness development, block resistance, water resistance, etc.

It would be desirable to have new aqueous coating compositions having reduced VOC content and/or improved coating performance properties.

### SUMMARY

The present invention provides aqueous coating compositions that in some embodiments, have low VOC content and/or improved coating performance properties. Examples of such coating performance properties, in some embodiments, include, a reduction in minimum film formation temperature, dispersion and wetting properties, coating stability (e.g., F-T stability, heat storage stability, etc.), and/or gloss.

In one aspect, the present invention provides an aqueous coating composition, such as paint, that comprises a binder and a coalescent according to Formula 1:

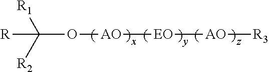

wherein R and Ri are each an alkyl group having 1 to 14 carbon atoms, wherein R₂ is hydrogen or an alkyl group having 1 to 13 carbon atoms, wherein the group formed by R, R₁, and R₂ contains 7 to 16 carbon atoms and has a branching degree of at least two, wherein R₃ is hydrogen, an alkyl group having 1 to 7 carbon atoms, or a benzyl group, wherein AO is an alkylene oxide having 3 to 6 carbon atoms, wherein EO is ethylene oxide, wherein x and z are each independently 0 to 6, and wherein the sum of x+y+z is 1 to 20.

These and other embodiments are described in more detail in the Detailed Description.

### DETAILED DESCRIPTION

As used herein, “a,” “an,” “the,” “at least one,” and “one or more” are used interchangeably. The terms “comprises,” “includes,” and variations thereof do not have a limiting meaning where these terms appear in the description and claims. Thus, for example, an aqueous composition that includes particles of “a” hydrophobic polymer can be interpreted to mean that the composition includes particles of “one or more” hydrophobic polymers.

Also herein, the recitations of numerical ranges by endpoints include all numbers subsumed in that range (e.g., 1 to 5 includes 1, 1.5, 2, 2.75, 3, 3.80, 4, 5, etc.). For the purposes of the invention, it is to be understood, consistent with what one of ordinary skill in the art would understand, that a numerical range is intended to include and support all possible subranges that are included in that range. For example, the range from 1 to 100 is intended to convey from 1.01 to 100, from 1 to 99.99, from 1.01 to 99.99, from 40 to 60, from 1 to 55, etc.

Some embodiments of the present invention relate to aqueous coating compositions, such as paints or other coatings. Aqueous coating compositions, in some embodiments, comprise a binder and a coalescent according to Formula 1:

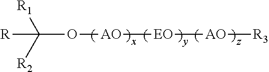

wherein R and R₁ are each an alkyl group having 1 to 14 carbon atoms, wherein R₂ is hydrogen or an alkyl group having 1 to 13 carbon atoms, wherein the group formed by R, R₁, and R₂ contains 7 to 16 carbon atoms and has a branching degree of at least two, wherein R₃ is hydrogen, an alkyl group having 1 to 7 carbon atoms, or a benzyl group, wherein AO is an alkylene oxide having 3 to 6 carbon atoms, wherein EO is ethylene oxide, wherein x and z are each independently 0 to 6, and wherein the sum of x+y+z is 1 to 20. In some embodiments, x is 0, y is 1 to 20, and z is 0.

In some embodiments, the molecular weight (Mₙ) of the coalescent is from 200 to 2,000. The molecular weight (Mₙ) of the coalescent, in some embodiments, is 250 to 1,500. In some embodiments, the molecular weight (Mₙ) of the coalescent is from 300 to 1,000.

In some embodiments, the binder is an aqueous polymeric dispersion that comprises an acrylic polymer, a styrene-acrylic copolymer, a vinyl acetate-acrylic copolymer, an ethylene-vinyl acetate copolymer, or a mixture thereof. In some embodiments where the binder is such an aqueous polymeric dispersion, the aqueous coating composition comprises 5 to 80 weight percent of the polymeric dispersion based on the total weight of the aqueous coating composition. In some embodiments, the aqueous coating composition comprises 10 to 70 weight percent of the polymeric dispersion based on the total weight of the aqueous coating composition. The aqueous coating composition comprises 15 to 60 weight percent of the polymeric dispersion based on the total weight of the aqueous coating composition in some embodiments.

The aqueous coating composition comprises 0.1 to 30 weight percent of a coalescent according to Formula 1 based on the weight of the binder on a total solids basis in some embodiments. An aqueous coating composition of the present invention, in some embodiments, comprises from 1 to 20 weight percent of a coalescent according to Formula 1 based on the weight of the binder on a total solids basis. In some embodiments, an aqueous coating composition of the present invention comprises from 2 to 15 weight percent of the coalescent, based on the weight of the binder on a total solids basis.

### Coalescent

The aqueous coating composition comprises a coalescent according to Formula 1:

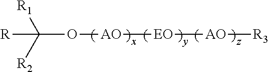

wherein R and R₁ are each an alkyl group having 1 to 14 carbon atoms, wherein R₂ is hydrogen or an alkyl group having 1 to 13 carbon atoms, wherein the group formed by R, R₁, and R₂ contains 7 to 16 carbon atoms and has a branching degree of at least two, wherein R₃ is hydrogen, an alkyl group having 1 to 7 carbon atoms, or a benzyl group, wherein AO is an alkylene oxide having 3 to 6 carbon atoms, wherein EO is ethylene oxide, wherein x and z are each independently 0 to 6, and wherein the sum of x+y+z is 1 to 20. In some embodiments, x and z are each 0, and y is 1 to 15. In some embodiments, x and z are each 0, and y is 2 to 16. In some embodiments, x and z are each 0, and y is 3 to 15. In some embodiments, x and z are each 0, and y is 3, 5, or 15. In some embodiments, x and z are each 0 and y is 3.

By “coalescent” is meant an ingredient that facilitates the film formation of a binder, particularly in an aqueous coating composition that includes a binder that is a dispersion of polymer in an aqueous medium (an aqueous polymeric dispersion) such as, for example, a polymer prepared by emulsion polymerization techniques. An indication of facilitation of film formation is that the minimum film forming temperature (“MFFT”) of the composition including the binder (aqueous polymeric dispersion) is measurably lowered by the addition of the coalescent. In other words, MITT values are indicative of how efficient a coalescent is for a given aqueous polymeric dispersion; it is desirable to achieve the lowest possible MFFT with the smallest amount of coalescent. MFFTs of the aqueous coating compositions herein are measured using ASTM D 2354 and a 5 mil MFFT bar as described in the Examples section.

In some embodiments, the molecular weight (Mₙ) of the coalescent is from 200 to 2,000. The molecular weight (Mₙ) of the coalescent, in some embodiments, is 250 to 1,500. In some embodiments, the molecular weight (Mₙ) of the coalescent is from 300 to 1,000.

Non-limiting examples of compounds according to Formula 1 that can be used as coalescents in aqueous coating compositions according to some embodiments of the present invention include TERGITOL™ 15-S-3 and TERGITOL™ 15-S-5, each of which is a secondary alcohol ethoxylate according to Formula 1 commercially available from The Dow Chemical Company, and TERGITOL™ TMN-3 which is a highly branched secondary alcohol ethoxylate according to Formula 1 commercially available from The Dow Chemical Company.

In some embodiments, an aqueous coating composition of the present invention comprises from 0.1 to 30% by weight of a coalescent according to Formula 1, based on the weight of the binder on a total solids basis. An aqueous coating composition of the present invention, in some embodiments, comprises from 1 to 20% by weight of a coalescent according to Formula 1 based on the weight of the binder on a total solids basis. In some embodiments, an aqueous coating composition of the present invention comprises from 2 to 15% by weight of the coalescent, based on the weight of the binder on a total solids basis.

In some embodiments, aqueous coating compositions of the present invention can further comprise one or more other coalescents in addition to coalescent according to Formula 1. The additional coalescent, in some embodiments, comprises at least one of propylene glycol phenyl ether, ethylene glycol phenyl ether, dipropylene glycol n-butyl ether, ethylene glycol n-butyl ether benzoate, tripropylene glycol n-butyl ether, 2,2,4-trimethyl-1,3-pentanediol monoisobutyrate, triethylene glycol bis-2-ethylhexanoate, and/or tributyl citrate. Such coalescents are commercially available from The Dow Chemical Company (e.g., UCAR™ Filmer IBT), Eastman Chemical Company (e.g., Eastman Optifilm Enhancer 400), and others.

### Binder

In addition to the coalescent of Formula 1, aqueous coating compositions of the present invention further comprise a binder. The binder can be part of an aqueous polymeric dispersion that comprises a polymer, oligomer, prepolymer, or a combination thereof in an aqueous medium. In some embodiments, the aqueous polymeric dispersion forms a film upon evaporation of water and can be reactive or non-reactive, depending on the desired formulation. By “aqueous medium” is meant herein a medium including at least 50%, by weight based on the weight of the medium, water. The polymer, oligomer, prepolymer, or combination in the aqueous polymeric dispersion is often referred to as a binder. The choice of binder is not particularly critical, and the binder can be selected from all type of binders known in the art including, for example, an acrylic polymer, a styrene-acrylic copolymer, a vinyl acetate-acrylic copolymer, an ethylene-vinyl acetate copolymer, or a mixture thereof, and hybrids of these and other chemistries. In some embodiments, the binder is a binder that is suitable for use for interior wall paint. In some embodiments, the binder is a binder that is suitable for use in exterior paint. In some embodiments, the binder is a binder that is suitable for use in a waterproofing paint, including one-component waterproofing paints and/or two-component paints.

The average particle diameter of the polymer particles in the dispersion is not particularly critical, and advantageously is from 40 nm to 1000 nm, preferably from 50 nm to 300 nm. Particle diameters herein are those measured by a Zetasizer Nano ZS from Malvern Panalytical Ltd.

### Aqueous Coating Compositions

In some embodiments, an aqueous coating composition of the present invention comprises: (a) a polymeric binder; (b) optionally, a pigment; (c) water; and (d) a coalescent according to Formula 1 as described hereinabove. In some embodiments, an aqueous coating composition of the present invention comprises: (a) a polymeric binder; (b) optionally, a pigment; (c) water; (d) a coalescent according to Formula 1 as described hereinabove; and (e) one or more nonionic surfactants.

Various embodiments of aqueous coating compositions of the present invention can be employed in uses such as, for example, wall paints, floor coatings, ceiling paints, exterior paints, and window frame coatings.

Aqueous coating compositions of the present invention can be prepared by techniques which are well known in the coatings art. For example, preparation of an aqueous coating composition includes a grind stage. For the grind stage, a number of components of the aqueous coating composition, such as the pigment, as well as other materials that may not homogenize under low-shear mixing and are selected for a particle size reduction, can be combined with water to be ground and/or dispersed (e.g. via a mill under high shear conditions). Other components, such as defoamer and/or wetting agent, among others, may be utilized in the grind stage.

The grind stage can provide that resultant particles have an average particle diameter from 0.1 μm to 100 μm. All individual values and subranges from 0.1 μm to 100 μm are included; for example, resultant particles may have an average particle diameter from a lower limit of 0.1, 0.5, or 1.0 μm to an upper limit of 100, 75, or 50 μm.

Following the grind stage, a let-down stage may be performed. The composition resulting from the grind stage (e.g., a number of ground and/or dispersed aqueous coating composition components) can be combined with the coalescent according to Formula 1 and the remaining components utilized to form the aqueous coating composition. The let-down stage may utilize low shear mixing, for instance.

The aqueous coating composition may include, in addition to the aqueous polymeric dispersion (with binder), coalescent, and optional pigment(s), conventional coatings adjuvants such as, for example, wetting agents, extenders, emulsifiers, plasticizers, curing agents, buffers, neutralizers, rheology modifiers, surfactants, humectants, biocides, antifoaming agents, UV absorbers, fluorescent brighteners, light and/or heat stabilizers, biocides, chelating agents, dispersants, colorants, waxes, and water-repellants.

The aqueous coating compositions disclosed herein may include a wetting agent, which may also be referred to as a surfactant and/or a dispersant in some embodiments. “Wetting agent” as used herein refers to a chemical additive that can reduce the surface tension and/or improve separation of particles of the aqueous coating compositions disclosed herein. Examples of wetting agents include, but are not limited to, alcohol ethoxylate wetting agents, polycarboxylate wetting agents, anionic wetting agents, zwitterionic wetting agents, non-ionic wetting agents, and combinations thereof. Specific examples of wetting agents that can be used in some embodiments include sodium bis(tridecyl) sulfosuccinate, sodium di(2-ethylhexyl) sulfosuccinate, sodium dihexylsulfosuccinate, sodium dicyclohexylsulfosuccinate, sodium diamylsulfosuccinate, sodium diisobutylsulfosuccinate, disodium iso-decylsulfosuccinate, the disodium ethoxylated alcohol half ester of sulfosuccinic acid, disodium alkylamidopolyethoxy sulfosuccinate, tetra-sodium N-(1,2-dicarboxyethyl)-N-octadecyl sulfosuccinamate, disodium N-octasulfosuccinamate, and sulfated ethoxylated nonylphenol, among others. Examples of commercially available wetting agents include, for example, ECOSURF™ EH-9 available from The Dow Chemical Company, OROTAN™ CA-2500 available from The Dow Chemical Company, SURFYNOL 104 available from Evonik, BYK-346 and BYK-349 polyether-modified siloxanes both available from BYK, among others.

The aqueous coating composition may include from 0.01 to 10 weight percent of the wetting agent based upon a total weight of the aqueous coating composition. All individual values and subranges from 0.01 to 10 weight percent are included; for example, the aqueous coating composition may include the wetting agent from a lower limit of 0.01, 0.1, 0.2, 1.0 or 2.0 weight percent to an upper limit of 10, 8, 7, 5, 4, or 3 weight percent based upon the total weight of the aqueous coating composition.

The pigment can be selected from the wide range of materials known to those skilled in the art of coatings, including, for example, organic and inorganic colored pigments. Examples of suitable pigments and extenders include titanium dioxide such as anatase and rutile titanium dioxides; zinc oxide; antimony oxide; iron oxide; magnesium silicate; calcium carbonate; aluminosilicates; silica; various clays such as kaolin and delaminated clay; and lead oxide. It is also contemplated that the aqueous coating composition may also contain opaque polymer particles, such as, for example, ROPAQUE™ Opaque Polymers (available from The Dow Chemical Company). Also contemplated are encapsulated or partially encapsulated opacifying pigment particles; and polymers or polymer emulsions adsorbing or bonding to the surface of pigments such as titanium dioxide such as, for example, EVOQUE™ polymers (available from The Dow Chemical Company); and hollow pigments, including pigments having one or more voids.

Titanium dioxide is a typical pigment used to achieve hiding in architectural paints.

The amounts of pigment and extender in the aqueous coating composition vary from a pigment volume concentration (PVC) of 0 to 85 and thereby encompass coatings otherwise described in the art, for example, as clear coatings, stains, flat coatings, satin coatings, semi-gloss coatings, gloss coatings, primers, textured coatings, and the like. The aqueous coating composition herein expressly includes architectural, maintenance, and industrial coatings, caulks, sealants, and adhesives. The pigment volume concentration is calculated by the following formula:

PVC (%)=(volume of pigment(s), +volume extender(s)×100)/(total dry volume of paint).

The solids content of the aqueous coating composition may be from 10% to 70% by volume. The viscosity of the aqueous coating composition may be from 50 centipoises to 50,000 centipoises, as measured using a Brookfield viscometer; viscosities appropriate for different application methods vary considerably, as is known to those skilled in the art.

The aqueous coating composition disclosed herein can be utilized to form coatings. These coatings may be used for a number of different coating applications such as industrial coating applications, architectural coating applications, automotive coating applications, outdoor furniture coating applications, among others.

In use, various embodiments of aqueous coating compositions of the present invention can typically be applied to a substrate such as, for example, wood, metal, plastic, marine and civil engineering substrates, previously painted or primed surfaces, weathered surfaces, and cementitious substrates such as, for example, concrete, stucco, and mortar. Various embodiments of aqueous coating compositions of the present invention may be applied to a substrate using conventional coating application methods such as, for example, brush, roller, caulking applicator, roll coating, gravure roll, curtain coater and spraying methods such as, for example, air-atomized spray, air-assisted spray, airless spray, high volume low pressure spray, and air-assisted airless spray.

Drying of the aqueous coating compositions to provide a coating may be allowed to proceed under ambient conditions such as, for example, at 5° C. to 35° C. or the coating may be dried at elevated temperatures such as, for example, from greater than 35° C. to 80° C.

Some embodiments of the invention will now be described in detail in the following Examples.

### EXAMPLES

The following examples are given to illustrate the invention and should not be construed as limiting its scope. All parts and percentages are by weight unless otherwise indicated.

### Coalescents and Binders

The Examples below use different coalescents. Three of the coalescents (Inventive Coalescents 1-3) are coalescents according to Formula 1, and represent coalescents that can be used in embodiments of aqueous coating compositions of the present invention.
Inventive Coalescent 1 is TERGITOL™ 15-S-3, which is a coalescent according to Formula 1 wherein x=0, y=3, and z=0, commercially available in the Dow Chemical Company.
Inventive Coalescent 2 is TERGITOL™ 15-S-5, which is a coalescent according to Formula 1 wherein x=0, y=5, and z=0, commercially available in the Dow Chemical Company.
Inventive Coalescent 3 is TERGITOL™ TMN-3, which is a coalescent according to Formula 1 wherein x=0, y=3, and z=0, commercially available in the Dow Chemical Company.

For comparison, the Comparative Examples use a conventional coalescent (Comparative Coalescent A), UCAR™ Filmer IBT, which is 2,2,4-trimethyl-1,3-pentanediol monoisobutyrate, commercially available from The Dow Chemical Company.

The binders used in the Examples are PRIMAL™ DC-420, which is a styrene-acrylate binder commercially available from The Dow Chemical Company, and PRIMAL™ AC-268, which is an acrylate binder commercially available from The Dow Chemical Company.

### Preparation of Paint Formulations

Paint formulations (types of aqueous coating compositions) are prepared to evaluate the performance of the Inventive Coalescents relative to the Comparative Coalescent. The paint formulations have a pigment volume concentration of 52%. The standard formulation used to prepare the paint formulations is shown in Table 1. The only difference in materials is the Coalescent used (Inventive Coalescent or Comparative Coalescent). Also, the total dosage of wetting agent and coalescent is adjusted to achieve a minimum film forming temperature (MFFT) of 1-2° C. Aqueous coating compositions made with an Inventive Coalescent are referred to as Inventive Coating Compositions, and aqueous coating compositions made with a Comparative Coalescent are referred to as Comparative Coating Compositions.

TABLE 1
Aqueous Coating Composition (Paint Formulation-52% PVC)

| Material | Ratio | |
|---|---|---|
| (Supplier) | (g/kg) | Function |
| [symbol] | | |
| Water | 165 | |
| Natrosol 250 HBR | 1.5 | Thickener |
| (Ashland) | | |
| Propylene Glycol | 12 | Freeze-Thaw |
| | | Stabilizer |
| ECOSURF ™ EH-9 | 1.5¹ | Wetting Agent |
| (The Dow Chemical Company) | | |
| AMP-95 | 1.5 | pH adjuster |
| (ANGUS Chemical Company) | | |
| OROTAN ™ CA-2500 | 7.5 | Dispersant |
| (The Dow Chemical Company) | | |
| ROCIMA ™ CF-1100 | 2.5 | Biocide |
| (The Dow Chemical Company) | | |
| BYK-024 | 1.0 | Defoamer |
| (BYK) | | |
| Titanium Dioxide | 200 | Colorant |
| Calcined Kaolin DB-80 | 35 | Filler |
| Calcium carbonate (CC-700) | 85 | Filler |
| [symbol] | [symbol] | |
| [symbol] | | |
| PRIMAL ™ AC-268 | 280 | Binder |
| (The Dow Chemical Company) | | (acrylic-based) |
| BYK-024 | 1.0 | Defoamer |
| (BYK) | | |
| Inventive Coalescent or | X¹ | Coalescent |
| Comparative Coalescent | | |
| ROPAQUE ™ Ultra E | 70 | Polymeric Pigment |
| (The Dow Chemical Company) | | |
| ACRYSOL ™ TT-935 | 3.5 | Thickener |
| (The Dow Chemical Company) | | |
| ACRYSOL ™ DR-7700 | 5.0 | Thickener |
| (The Dow Chemical Company) | | |
| KATHON ™ LXE | 2.0 | Biocide |
| (The Dow Chemical Company) | | |
| AMP-95 | 0.5 | pH Adjuster |
| (ANGUS Chemical Company) | | |
| ACRYSOL ™ RM-2020 NPR | 10.0 | Rheology Modifier |
| (The Dow Chemical Company) | | |
| Water | 100.5 | |
| [symbol] | ~487.5 | |
| [symbol] | ~1000 | |

¹The total dosage of Coalescent is adjusted to achieve the MFFT around 1.0-2.0° C. as illustrated below. For the Inventive Coating Compositions, the Inventive Coalescent does not require a Wetting Agent.

Each of the Inventive and Comparative Coating Compositions are prepared as follows. Water is added to a two liter stainless steel canister, followed by the specified freeze-thaw stabilizer (propylene glycol), dispersant (OROTAN™ CA-2500), and defoamer (BYK-024) with stirring by dispersion plate at around 400 rpm. A thickener (Natrosol 250HBR) is slowly added into the above mixture, and the mixture stirred for two minutes. The specified pH adjuster (AMP-95) is poured into the mixture and continuously stirred for 10 minutes, and the mixture becomes thick gradually. The colorant (titanium dioxide) and fillers (Calcined Kaolin DB-80 and Heavy Calcium Carbonate CC-700) are added to the mixture. The dispersing speed is raised to 2000 rpm with gradually increasing viscosity.

This mixture is kept dispersing for 30 minutes or even longer until no particles having a size larger than 50 microns are observed in order to assure homogeneous dispersion.

The specified binder (PRIMAL™ AC-268) is then added to the mixture, followed by additional defoamer (BYK-024 in the Let Down), pH adjuster (AMP-95 in the Let Down), polymeric pigment (ROPAQUE™ Ultra E). A small size dispersion plate is used for stirring at 1000 rpm for 10 minutes.

The specified thickeners and rheology modifier (ACRYSOL™ TT-935, DR-7700 and RM2020 NPR), and the remaining water are then added into the mixture with stirring for another 10 minutes.

The mixture is divided into 2 parts (2 formulations), and the specified wetting agent and coalescent are added into each part.

### Minimum Film Formation Temperature

The minimum film formation temperature (MFFT) reduction efficiency of certain Inventive Coalescents is measured and compared to that of the Comparative Coalescent. The ability of these compounds to reduce the MFFT of a water-based, acrylic co-polymer emulsion binder (PRIMAL™ DC-420) is evaluated.

The MFFT is measured in accordance with ASTM D2354. A MFFT-Bar.90 is used for the MFFT test with a temperature range from −10 to 90° C. The binder is stirred at 300 rpm during coalescent addition to ensure effective dispersing and mixing. After the addition of coalescent, the mixture is kept stirring at 300 rpm for 10 more minutes, and stored at room temperature for 1 day to ensure a homogeneous mixture. The mixture is applied to a plastic film on the MFFT tester (RHOPOINT MFFT-90) with a 75 μm wet film. After 2 hours, the film appearance is checked, and the temperature at which the film cracked is recorded. Each of the specified coalescents are measured at a concentration of 3 weight percent based on the weight of the binder and 5 weight percent based on the weight of the binder. The results are shown in Table 2:

TABLE 2

| | MFFT | MFFT | MFFT | Surface Tension | |
|---|---|---|---|---|---|
| | @ 0 wt % | @ 3 wt % | @ 5 wt % | @ 5 wt % | |
| Coalescent | (° C.) | (° C.) | (° C.) | (mN/m) | HLB¹ |
| No | 34.2 | | | 37.6 | |
| Coalescent | | | | | |
| Comparative | | 15.1 | 7.9 | 33.5 | — |
| Coalescent A | | | | | |
| Inventive | | 18.5 | 13.1 | 31.9 (3 wt %) | 8.0 |
| Coalescent 1 | | | | 35.7 (5 wt %)² | |
| Inventive | | 22.2 | 16.7 | 29.6 | 10.5 |
| Coalescent 2 | | | | | |
| Inventive | | 19.0 | 12.2 | 29.4 | 8.1 |
| Coalescent 3 | | | | | |

¹Hydrophile-Lipophile Balance from the Technical Data Sheets for the specified coalescents.
²When 5 weight % of Inventive Coalescent 1 is added into the binder, the binder viscosity increased which could impact the surface tension measurement. No thickening effect is observed when measured at 3 weight %.

The data in Table 2 lead to the following observations. Inventive Coalescent 1 and Inventive Coalescent 2 showed MFFT reduction despite being less efficient than Comparative Coalescent A. Increasing of coalescent hydrophilicity (HLB) very clearly lowers the MFFT reduction efficiency. The data for Inventive Coalescents 1 and 2 show that the higher the HLB, the worse the MFFT reduction efficiency. Regarding surface tension, Comparative Coalescent A lowers the surface tension slightly relative the coalescent-free binder. The binders mixed with Inventive Coalescents 1-3 significantly lowered the surface tension relative to the coalescent-free binder. In summary, the Inventive Coalescents are able to reduce the binder's MFFT, while also lowering the surface tension of the binder.

The effect of certain Inventive Coalescents on MFFT are also evaluated in aqueous coating compositions. To meet requirements for low volatile organic compound (VOC) emission in high grade interior wall coatings, coating (paint) manufacturers generally use high performance ingredients with low VOC emissions. For this reason, the formulations used in these examples is an aqueous coating composition that is a high grade of interior wall coating with 52% PVC.

Table 3 shows three different formulations that are evaluated. The formulations prepared are as described above with Table 1, except that Table 3 shows the amount of Wetting Agent (ECOSURF™ EH-9) and/or Coalescent used. Considering the Coalescents' different efficiencies in MFFT reduction, the dosage of coalescent in the coating compositions are adjusted to maintain the same MFFT (≈1-2° C.) for the binder PRIMAL™ AC-268. The MFFT of PRIMAL™ AC-268 according to its technical data sheet is <14° C. Comparative Coating Composition A followed the formulation of Table 1. For Inventive Coating Composition 1, Inventive Coalescent 1 is the coalescent in the formulation of Table 1; at a dosage of 4.0 weight percent of Inventive Coalescent 1 based on the weight of the binder (this corresponds to 8.33 weight percent Inventive Coalescent 1 based on weight of the binder on a total solids basis), the final MFFT was similar to the final MFFT for Comparative Composition A; and, no Wetting Agent (ECOSURF™ EH-9) is required as Inventive Coalescent 1 lowers the surface tension of the binder in Table 2. For Inventive Coating Composition 2, Inventive Coalescent 3 is the coalescent in the formulation of Table 1; at a dosage of 4.0 weight percent of Inventive Coalescent 3 based on the weight of the binder (this corresponds to 8.33 weight percent Inventive Coalescent 3 based on weight of the binder on a total solids basis), the final MFFT was similar to the final MITT for Comparative Composition A; and, no Wetting Agent (ECOSURF™ EH-9) is required as Inventive Coalescent 3 lowers the surface tension of the binder in Table 2.

TABLE 3

| | | Wetting | | | |
|---|---|---|---|---|---|
| | | Agent | | Coalescent | |
| | Wetting | Amount | | Amount | MFFT |
| Formulation | Agent | (wt. %) | Coalescent | (wt. %) | (° C.) |
| Comparative | ECOSURF ™ | 0.15 | Comparative | 3.0 | 1.0 |
| Coating | EH-9 | | Coalescent A | | |
| Composition | | | | | |
| A | | | | | |
| Inventive | — | — | Inventive | 4.0 | 1.5 |
| Coating | | | Coalescent 1 | | |
| Composition | | | | | |
| 1 | | | | | |
| Inventive | — | — | Inventive | 4.0 | 2.1 |
| Coating | | | Coalescent 3 | | |
| Composition | | | | | |
| 2 | | | | | |

With Coating Compositions having comparable MFFT values prepared, other properties of the Coating Compositions are measured.

### VOC Emissions

The Coating Compositions prepared in Table 3 are evaluated for VOC emissions. As previously noted, it would be desirable to have new aqueous coating compositions with low VOC emissions.

The VOC content of the Coating Compositions in Table 3 are measured by GC Headspace as follows. The measurement is conducted using the GB 18582-2008 method (Indoor decorating and refurbishing materials—limit of harmful substances of interior architectural coatings). The analyses of the Coating Compositions are performed on an Agilent 7890A gas chromatograph, 5975C mass spectrometer with triple-axis detector. An aliquot of 2.0 gram (recorded accurately) homogenized sample is weighted into a 20 ml centrifuge vial, adding 5 milliliters of acetonitrile (ACN) which contained internal standard (2-(2-ethoxyethoxy)-ethanol, 3000 ppm) and VOC marker (hexanedioic acid, diethyl ester), with the exact weight of ACN being recorded. The sample is vortex centrifuged for 1 minute, followed by 5 minutes standing, vortexed again for 1 minute, and then centrifuged at 4000 rpm for 20 minutes. The supernatant of the sample is taken out and filtered through a 0.45 um syringe filter. The filtrate is then injected into a GC-MS system with the conditions as follows.

[Oven Program]
Initial 45° C., held for 4 minutes, then at a rate of 8° C./min to 230° C., held for 10 minutes
Run Time: 37.125 minutes
Flow rate: 1 mL/min
Average Velocity: 36.4 cm/sec

[Column]
HP-5MS 5% Phenyl Methyl Siloxane
Length×Diameter×Film thickness: 30 m×250 μm×1.0 μm

[MS SCAN and SIM Parameters]
Obtain FASTSCAN data
Low Mass: 29.0
High Mass: 350.0
GC-MS inlet temperature: 250° C.
GC-MS inlet split ratio: 10:1
   The injection volume is 1 microliter. The concentrations of various VOCs are measured by comparing with the peak area of the internal standard. The response factor of all VOCs is regarded as 1.2 to internal standard.

The VOC results are summarized in Table 4.

TABLE 4

| | | Wetting | | | |
|---|---|---|---|---|---|
| | | Agent | | Coalescent | |
| | Wetting | Amount | | Amount | VOC |
| Formulation | Agent | (wt. %) | Coalescent | (wt. %) | (ppm) |
| Comparative | ECOSURF ™ | 0.15 | Comparative | 3.0 | 765 ± |
| Coating | EH-9 | | Coalescent A | | 12 |
| Composition | | | | | |
| A | | | | | |
| Inventive | — | — | Inventive | 4.0 | 446 ± |
| Coating | | | Coalescent 1 | | 21 |
| Composition | | | | | |
| 1 | | | | | |
| Inventive | — | — | Inventive | 4.0 | 782 ± |
| Coating | | | Coalescent 3 | | 24 |
| Composition | | | | | |
| 2 | | | | | |

As shown in Table 4, Inventive Coating Composition 1 has a much lower VOC than Comparative Coating Composition A, and Inventive Coating Composition 2 has a VOC comparable to that of Comparative Coating Composition A.

### Heat Storage Stability and Freeze-Thaw Stability

The heat storage stability and freeze-thaw stability of Comparative Coating Composition A and Inventive Coating Composition 1 are evaluated.

Heat storage stability is measured according to GB/T 20623-2006. 200 grams of the Coating Compositions is sealed in a jar and put in the oven at 50±2° C. for 10 days. After taking the Coating Composition sample out of the oven, the sample is kept at 23±2° C. for 3 hours. The homogeneity of the Coating Composition Sample is visually inspected, and its KU viscosity is measured. The results are shown in Table 5.

Freeze-thaw (F-T) stability is measured according to GB/T 20623-2006. 200 grams of the Coating Composition is sealed in ajar and put in a refrigerator at −5±2° C. (−6° C. in this test) for 18 hours. After removing the Coating Composition sample from the refrigerator, it is kept at room temperature for 6 hours. This is one F-T testing cycle. The appearance of the Coating Composition is visually checked after each cycle, and the KU viscosity is measured after 3 cycles. No sedimentation or phase separation of the coating after 3 cycles results in a pass rating. Then, 2 additional cycles at −6° C. are conducted in order to differentiate the freeze-thaw stability of the Coating Compositions. The final KU viscosity is also measured. The results are shown in Table 5.

TABLE 5

| | | Comparative | |
|---|---|---|---|
| | | Coating | Inventive Coating |
| | | Composition A | Composition 1 |
| | Wetting Agent | 0.15 wt. % | — |
| | | ECOSURF ™ | |
| | | EH-9 | |
| | Coalescent | 3.0 wt. % | 4.0 wt. % Inventive |
| | | Comparative | Coalescent 1 |
| | | Coalescent A | |
| | KU Overnight | 99.3 | 93.8 |
| Freeze-Thaw | KU | 98.7 | 93.0 |
| 3 cycles, −6° C. | ΔKU | −0.6 | −0.8 |
| Freeze-Thaw | KU | 103.8 | 95.1 |
| 5 cycles, −6° C. | ΔKU | 4.5 | 1.3 |
| | Appearance | No water bleeding, | No water bleeding, |
| | | very fine particles | very fine particles |
| Heat Storage | KU | 113 | 97.4 |
| (50° C., 10 days) | ΔKU | 13.7 | 3.6 |

As to freeze-thaw stability, the results in Table 5 show that after 3 cycles (one cycle: −6° C. for 18 hour and room temperature for 6 hours), both of the coatings are very good with negligible viscosity change. After 5 cycles, Inventive Coating Composition 1 is slightly better than Comparative Coating Composition A with less change in KU viscosity. For heat storage stability, Inventive Coating Composition 1 is quite stable in comparison with Comparative Coating Composition A. In short, the use of Inventive Coalescent 1 in an aqueous coating composition (Inventive Coating Composition 1) provides both good freeze-thaw stability and good heat storage stability in a high grade interior wall coating.

### Gloss and Color Development

Formation of a homogeneous slurry is an indicator of a good dispersion effect of an aqueous coating composition. It offers good gloss in high grade interior wall coatings; meanwhile, it improves coating color development to ensure the uniform color of coating films during application. The gloss and color development of Inventive Coating Composition 1 and Comparative Coating Composition A are also measured.

To measure gloss, the Coating Composition to be measured is used to form a coating film having a thickness of 150 microns by an applicator on a standard black-white paperboard, and dried at 23±2° C. and 50±5% relative humidity for 7 days. The gloss is measured using a BYK Gloss Tester.

The color development test is measured using a rub-up test method. A color pigment is used in the test by mixing at a weight ratio of 1/50 within the Coating Composition. Red, blue, and black pigments are evaluated. After stirring well, the Coating Composition with pigments is applied as a coating layer with a thickness of 150 microns on the white plate. Then, immediately the coating film is wiped out by circling an operator's right middle finger gently over the coating film. The diameter of the circle is approximately 3-4 cm, with a total of about 45 circles. Smooth and uniform wiping is needed to prevent from wearing through the coating film. After rubbing up, the coating film is kept in an ASTM room (23° C.±2° C.; 50%±5% relative humidity) for 1 day. Then, the color difference of the circle and non-circle area is measured by SHEEN colorimeter.

The results of the gloss and color development tests are shown in Table 6.

TABLE 6

| | | Comparative | |
|---|---|---|---|
| | | Coating | Inventive Coating |
| | | Composition A | Composition 1 |
| | Wetting Agent | 0.15 wt. % | |
| | | ECOSURF ™ EH-9 | |
| | Coalescent | 3.0 wt. % | 4.0 wt. % Inventive |
| | | Comparative | Coalescent 1 |
| | | Coalescent A | |
| Gloss | 20° | 1.8 | 1.9 |
| | 60° | 4.6 | 6.0 |
| | 85° | 14.2 | 16.0 |
| Color | Blue ΔE | 0.28 | 0.40 |
| Development | Red ΔE | 0.25 | 0.15 |
| | Black ΔE | 0.17 | 0.13 |
| | Total ΔE | 0.70 | 0.68 |

As shown in Table 6, there is no significant gloss difference at 20° for both Coating Compositions. At 60° and 85°, Inventive Coating Composition 1 demonstrated higher gloss than Comparative Coating Composition A.

Regarding the color development test, ΔE is given to show the color difference between the rubbed area and the non-rubbed area. The smaller the ΔE, the better the color development. A ΔE range of 0.5 is generally considered as an acceptable level by customers. In Table 6, Inventive Coating Composition 1 showed similar color development relative to Comparative Coating Composition A.

In brief, both gloss and color development test results show that Inventive Coating Composition 1 utilizing Inventive Coalescent 1 performs slightly better than Coating Composition A utilizing Comparative Coalescent A.

Overall, the above results show that coalescents according to Formula 1 (e.g., Inventive Coalescents 1-3) have slightly less MFFT reduction efficiency than Comparative Coalescent A, but demonstrate other useful properties, such as lowering a binder's surface tension, lower VOC content, better coating stability, and higher gloss in architectural coatings.

1. An aqueous coating composition comprising a binder and a coalescent according to Formula 1: 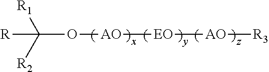
wherein R and Ri are each an alkyl group having 1 to 14 carbon atoms, wherein R₂ is hydrogen or an alkyl group having 1 to 13 carbon atoms, wherein the group formed by R, R₁, and R₂ contains 7 to 16 carbon atoms and has a branching degree of at least two, wherein R₃ is hydrogen, an alkyl group having 1 to 7 carbon atoms, or a benzyl group, wherein AO is an alkylene oxide having 3 to 6 carbon atoms, wherein EO is ethylene oxide, wherein x and z are each independently 0 to 6, and wherein the sum of x+y+z is 1 to 20.

2. The coating composition of claim 1, wherein x is 0, y is 1 to 20, and z is 0.

3. The coating composition of claim 1, wherein the molecular weight (Mₙ) of the coalescent is from 200 to 2,000.

4. The coating composition of claim 1, wherein the binder is an aqueous polymeric dispersion that comprises an acrylic polymer, a styrene-acrylic copolymer, a vinyl acetate-acrylic copolymer, an ethylene-vinyl acetate copolymer, or a mixture thereof.

5. The coating composition of claim 4, wherein the aqueous coating composition comprises 5 to 80 weight percent of the polymeric dispersion based on the total weight of the aqueous coating composition.

6. The coating composition of claim 1, wherein the aqueous coating composition comprises 0.1 to 30 weight percent of the coalescent based on the weight of the binder on a total solids basis.
